(19) United States
(12) Patent Application Publication
(10) Pub. No.: US 2007/0046174 A1
(43) Pub. Date: Mar. 1, 2007

(54) Electron emission display

(76) Inventor: Seung-Hyun Lee, Suwon-si (KR)

Correspondence Address: Robert E. Bushnell, Suite 300, 1522 K Street, N.W., Washington, DC, 20005-1202, US

(21) Appl. No.: 11/508,225

(22) Filed: Aug. 23, 2006

(30) Foreign Application Priority Data
Aug. 30, 2005 (KR) 10-2005-0080010

(51) Int. Cl. H01J 63/04; H01J 1/62

(52) U.S. Cl. 313/495; 313/497; 313/496

(57) ABSTRACT

An electron emission includes: first and second substrates arranged to face each other; an electron emission region arranged on the first substrate; a plurality of driving electrodes arranged on the first substrate and adapted to control electron emission of the electron emission region; a focusing electrode arranged above the driving electrodes and including openings adapted to focus electrons passing therethrough; and phosphor layers arranged on the second substrate, the phosphor layers respectively corresponding to each pixel region on the first substrate. The openings and the phosphor layer satisfy the following inequality: F2<D2<(F2+2P1−D1−F1). F1 is a first width of the openings in a first direction of the first and second substrates, D1 is a first width of the phosphor layers in the first direction, F2 is a second width of the openings in a second direction perpendicular to the first direction, D2 is a width of the phosphor layers in the second direction, and P1 is a pitch between the pixel regions in the first direction.

### CLAIM OF PRIORITY

This application makes reference to, incorporates the same herein, and claims all benefits accruing under 35 U.S.C.§119 from an application for ELECTRON EMISSION DISPLAY DEVICE, earlier filed in the Korean Intellectual Property Office on the 30th of Aug. 2005 and there, duly assigned Serial No. 10-2005-0080010.

### BACKGROUND OF THE INVENTION

1. Field of the Invention

The present invention relates to an electron emission display, and more particularly, to an electron emission display, in which a width of a phosphor layer has been optimized to improve light emission uniformity of pixel regions and to improve luminescence.

2. Description of Related Art

Generally, electron emission elements are classified into those using hot cathodes as an electron emission source, and those using cold cathodes as the electron emission source. There are several types of cold cathode electron emission elements, including Field Emitter Array (FEA) elements, Surface Conduction Emitter (SCE) elements, Metal-Insulator-Metal (MIM) elements, and Metal-Insulator-Semiconductor (MIS) elements.

The FEA element includes electron emission regions and cathode and gate electrodes that are driving electrodes. The electron emission regions are formed of a material having a relatively low work function or a relatively high aspect ratio, such as a carbonaceous material or a nanometer-size material, so that electrons can be effectively emitted when an electric field is applied thereto under a vacuum atmosphere.

The electron emission elements are arrayed on a first substrate to establish an electron emission unit. The electron emission unit is associated with a second substrate, on which a light emission unit having a phosphor layer, a black layer and an anode electrode is formed, to establish an electron emission display.

In the electron emission display, some of the electrons emitted from an electron emission region do not travel straight towards a phosphor layer of a corresponding pixel but rather spread out toward a phosphor layer of an adjacent pixel.

In order to prevent the electrons from spreading out, a focusing electrode is provided. The focusing electrode is insulated from the driving electrodes by an insulating layer and is disposed on the driving electrodes. The focusing electrode is provided with openings through which electrons pass. As the electrons pass through the openings, the electrons are focused into an electron beam.

The electron emission display can realize a high quality display when the electron beam spot accurately strikes the phosphor layer of the corresponding pixel.

That is, when the electron beam spot diverges in a direction where phosphor layers of differing colors are arranged, a phosphor layer of an undesirable color is excited to deteriorate the color purity of the screen. When the electron beam spot diverges in a direction where phosphor layers of an identical color are arranged, the luminescence is deteriorated. When the electron beam spot is smaller than a width of the phosphor layer, the light emission quality and the luminescent uniformity of the pixel regions are deteriorated.

Therefore, there is a need to optimize the relationship between the openings of the focusing electrode and the phosphor layers on which the electron beams land.

### SUMMARY OF THE INVENTION

The present invention provides an electron emission display, in which a width of a phosphor layer is optimized to improve light emission uniformity of pixel regions and to improve luminescence and to prevent a phosphor layer of an undesirable color from being excited.

In an exemplary embodiment of the present invention, an electron emission display includes: first and second substrates arranged to face each other; an electron emission region arranged on the first substrate; a plurality of driving electrodes arranged on the first substrate and adapted to control electron emission of the electron emission region; a focusing electrode arranged above the driving electrodes and including openings adapted to focus electrons passing therethrough; and phosphor layers arranged on the second substrate, the phosphor layers respectively corresponding to each pixel region on the first substrate. The openings and the phosphor layer satisfy the following inequality: F2<D2<(F2+2P1−D1−F1). F1 is a first width of the openings in a first direction of the first and second substrates, D1 is a first width of the phosphor layers in the first direction, F2 is a second width of the openings in a second direction perpendicular to the first direction, D2 is a width of the phosphor layers in the second direction, and P1 is a pitch between the pixel regions in the first direction.

The first direction is preferably a horizontal direction of the first and second substrates and the second direction is preferably a vertical direction of the first and second substrates.

The phosphor layers preferably include red, green and blue phosphor layers and the phosphor layers of differing colors are preferably alternately arranged in the first direction and the phosphor layers of an identical color are preferably arranged in the second direction.

Lateral axes of the openings and the phosphor layers are preferably in the first direction and longitudinal axes of the openings and the phosphor layers are preferably in the second direction.

The openings of the focusing electrodes preferably include one of a rectangular shape, an oval shape and a track shape.

The phosphor layers preferably include either a rectangular shape or a rectangular shape having rounded corners.

One of the openings on the focusing electrodes are preferably provided for each pixel region defined on the first substrate.

Two or more openings on the focusing electrodes are preferably provided for each pixel region defined on the first substrate and the second width F2 of the openings is preferably defined between upper and lower ends of the openings arranged at each pixel region in the second direction.

The driving electrodes preferably include first and second electrodes with an insulating layer interposed therebetween and the electron emission region is preferably electrically connected to one of the first and second electrodes.

The electron emission region preferably includes a material selected from the group consisting of carbon nanotubes, graphite, graphite nanofibers, diamonds, diamond-like carbon, C₆₀, and silicon nanowires.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial exploded perspective view of an electron emission display according to an embodiment of the present invention;

FIG. 2 is a partial sectional view taken along an X-axis of FIG. 1;

FIG. 3 is a partial sectional view taken along a Y-axis of FIG. 1;

FIG. 4 is a partial top view of an electron emission display of FIG. 1;

FIG. 5 is an enlarged photograph of a light emission pattern of phosphor layers of an electron emission display of a first comparative example;

FIG. 6 is an enlarged photograph of a light emission pattern of phosphor layers of an electron emission display of a second comparative example;

FIG. 7 is an enlarged photograph of a light emission pattern of phosphor layers of the electron emission display of FIG. 1; and

FIG. 8 is a partial top view of an electron emission unit of an electron emission display according to another embodiment of the present invention.

### DETAILED DESCRIPTION OF THE INVENTION

The present invention is described more fully below with reference to the accompanying drawings, in which exemplary embodiments of the present invention are shown.

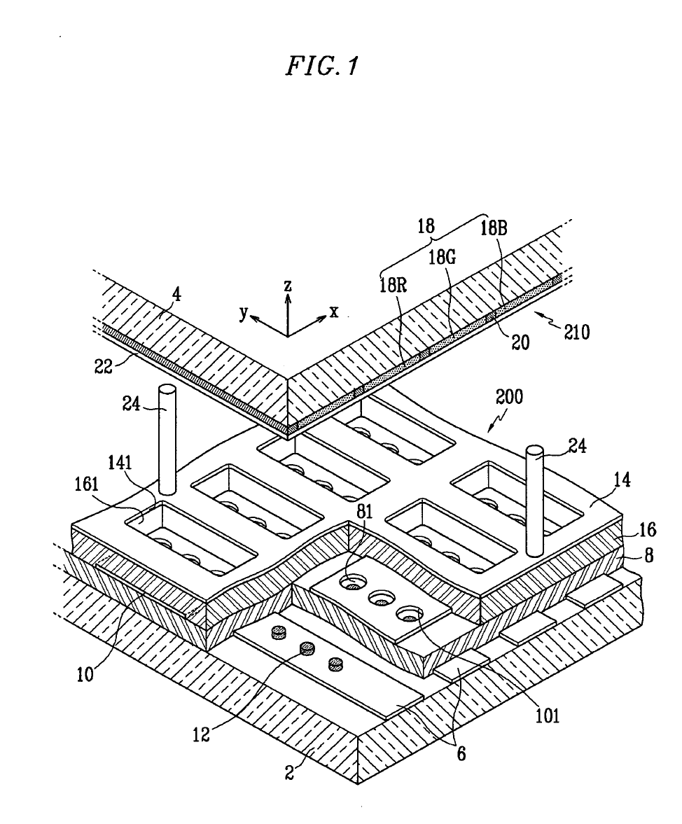

FIGS. 1 through 3 are views of an electron emission display according to an embodiment of the present invention.

Referring to FIGS. 1 through 3, an electron emission display according to an embodiment of the present invention includes first and second substrates 2 and 4 spaced apart and facing each other. A sealing member (not shown) is provided at the peripheries of the first and the second substrates 2 and 4 to seal them together and thus form a sealed vacuum vessel. The interior of the vacuum vessel is kept at a degree of vacuum of about 10⁻⁶ torr.

An electron emission unit 200 having an array of electric emission elements is formed on a surface of the first substrate 2 facing the second substrate 4. A light emission unit 210 is formed on a surface of the second substrate 4 facing the first substrate.

Cathode electrodes 6 are arranged on the first substrate 2 in a stripe pattern and a first insulating layer 8 is formed on the first substrate 2 to fully cover the cathode electrodes 6. Gate electrodes 10 are arranged on the first insulating layer 8 in a stripe pattern, the gate electrodes 10 crossing the cathode electrodes 6 at right angles.

The crossed regions of the cathode electrodes 6 and the gate electrodes 10 define pixel regions. One or more electron emission regions 12 are formed on the cathode electrodes 6 at each pixel region. Openings 81 and 101 corresponding to the electron emission region 12 are formed through the first insulating layer 8 and the gate electrodes 10 to expose the electron emission region 12.

The electron emission regions 12 are formed of a material that emits electrons when an electric field is applied in a vacuum. For example, the electron emission regions 12 can be formed of carbon nanotubes, graphite, graphite nanofibers, diamonds, diamond-like carbon, C₆₀, silicon nanowires, or a combination thereof. The electron emission regions 12 can be formed through a screen-printing process, a Chemical Vapor Deposition (CVD) process, a direct growth process, or a sputtering process.

In the drawings, although the electron emission regions 12 and the openings 101 are formed in a circular shape and arranged in series in a longitudinal direction of the cathode electrodes 6 at each pixel region, the present invention is not limited thereto. That is, the number, shape and arrangement of the electron emission regions 12 can be varied.

In addition, although the gate electrodes 10 are disposed above the cathode electrodes 6 with the first insulating layer 8 interposed therebetween, the present invention is not limited thereto. For example, the cathode electrodes can be disposed above the gate electrodes with the first insulating layer interposed therebetween. In this case, the electron emission regions can be formed on side surfaces of the cathode electrodes.

A second insulating layer 16 is formed on the first insulating layer 8 to cover the gate electrodes 10 and a focusing electrode 14 is formed on the second insulating layer 16. Openings 161 and 141 through which electron beams pass are formed through the second insulating layer 16 and the focusing electrode 14.

The greater the height difference between the focusing electrode 14 and the electron emission regions 12, the stronger the focusing effect. Therefore, the second insulating layer 16 is formed to have a thickness greater than that of the first insulating layer 8.

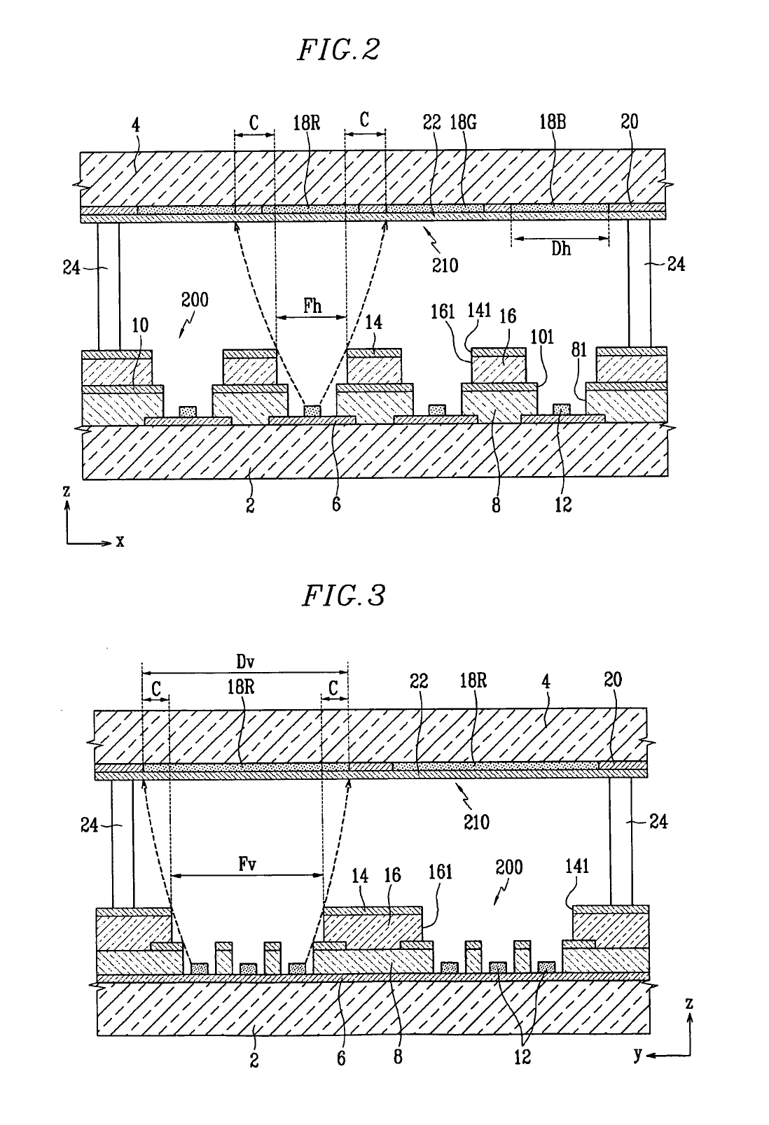

In this embodiment, each pixel region corresponds to each of the openings 141 of the focusing electrode 14 so that electrons emitted from one pixel region can be focused while passing through the corresponding one opening 141. Each opening 141 has a pair of longitudinal sides formed in a longitudinal direction of the cathode electrode 6 and a pair of lateral sides formed in a lateral direction of the cathode electrode 6. That is, the openings 141 are formed in an oblong shape. In FIGS. 2 and 3, the reference characters Fh and Fv respectively indicate length and width.

The openings 141 can be formed in a rectangular shape, an oval shape, a track shape, or the like.

Phosphor layers 18, such as red (R), green (G) and blue (B) phosphor layers 18R, 18G and 18B, are formed on a surface of the second substrate 4 opposite to the first substrate 2 and black layers 20 for enhancing the contrast of the screen are arranged between the R, G and B phosphor layers 18R, 18G and 18B.

Each crossed region of the cathode and gate electrodes 6 and 10 corresponds to a single color phosphor layer. For example, phosphor layers of differing colors are arranged in a first direction (a direction of an X-axis in the drawing) of the second substrate 4 and the phosphor layers of an identical color are arranged in a second direction (a direction of a Y-axis in the drawing) perpendicular to the first direction.

In FIGS. 2 and 3, the reference characters Dh and Dv respectively indicate length and width of each phosphor layer 18. The phosphor layers 18 are formed in a rectangular shape or a rectangular shape having rounded corners.

An anode electrode 22 formed of a conductive material, such as aluminum, is formed on the phosphor and black layers 18 and 20. The anode electrode 22 functions to improve the screen luminance by receiving a high voltage required for accelerating the electron beams and reflecting the visible light rays radiated from the phosphor layer 18 to the first substrate 2 towards the second substrate 4, thereby improving the screen luminance.

Alternatively, the anode electrode 22 can be formed of a transparent conductive material, such as Indium Tin Oxide (ITO), instead of the metallic material. In this case, the anode electrode is placed on the second substrate 4 and the phosphor and black layers 18 and 20 are formed on the anode electrode. Alternatively, the anode electrode can include both a metallic layer and a transparent conductive layer.

Spacers 24 are disposed between the first and second substrates 2 and 4 to uniformly maintain a gap therebetween. The spacers 24 are arranged corresponding to the black layers 20 so that the spacers 24 do not block the phosphor layers 18.

The above-described electron emission display is driven when a predetermined voltage is supplied to the cathode, gate, focusing, and anode electrodes 6, 10, 14, and 22.

For example, one of the cathode and gate electrodes 6 and 10 serves as scan electrodes receiving a scan driving voltage and the other functions as data electrodes receiving a data driving voltage. The focusing electrode 14 receives 0V or a negative DC voltage of several to tens of volts. The anode electrode 22 receives a DC voltage of, for example, hundreds to thousands of volts to accelerate the electron beams.

Electric fields are formed around the electron emission regions 12 of pixel regions where a voltage difference between the cathode and gate electrodes 6 and 10 is equal to or greater than a threshold value and the electrons are thus emitted from the electron emission regions 12. The emitted electrons strike the phosphor layers 18 of the corresponding pixel due to the high voltage supplied to the anode electrode 22, thereby exciting the phosphor layers 18.

When the electron emission display operates, the shapes of the openings 141 and the phosphor layers 18 act as important factors determining the luminescence of the phosphor layers and the light emission uniformity of the pixel regions. Considering this, the vertical width Dv of each phosphor layer 18 is determined according to the following Inequality 1.
Fv<Dv<(Fv+2C) Inequality 1:

where, Fv is a vertical width of the opening 141 and C is a length of a diverging region of an electron beam spot from an end of the opening 141 of the focusing electrode in a longitudinal direction of the phosphor layer 18.

That is, the vertical width Dv of the phosphor layer 18 is formed to be greater than the vertical width Fv of the opening 141 of the focusing electrode 14 but less than the vertical width Fv+2C of the electron beam spot that diverges. When the vertical width Dv of the phosphor layer 18 is less than the vertical width Fv of the opening 141, the phosphor layer 18 cannot provide a sufficient light emission area, thereby reducing the luminescence. When the vertical width Dv of the phosphor layer 18 is greater than the vertical width Fv+2C of the electron beam spot, an ineffective light emission region is formed, thereby reducing the light emission efficiency of the phosphor layer and the light emission uniformity of the pixel regions.

Therefore, in this embodiment, the electron emission display is designed to satisfy the aforementioned condition and to thereby improve the electron beam utilizing efficiency. That is, the light emission efficiency of the phosphor layers 18 can be improved to enhance the luminescence of the screen and to improve the light emission uniformity of the pixel regions.

At this point, the length of the diverging region C is set considering a condition for preventing the electron beam from trespassing an adjacent phosphor layer 18 in the lateral direction of the phosphor layer 18 when the electron beam has a diverging region having horizontal and vertical lengths identical to each other.

FIG. 4 is a partial top view of the phosphor layers and the black layers.

In FIG. 4, the reference characters Ph and b respectively indicate a horizontal pitch between the pixel regions and a horizontal width of the black layer 20 in the lateral direction of the phosphor layer 18.

Referring to FIGS. 2 and 4, the electrons passing through the opening 141 of the focusing electrode 14 reach the second substrate 4 while having diverging regions having the predetermined length C extending from left and right ends of the opening 141 in the lateral direction of the phosphor layer 18.

At this point, the horizontal width Fh+2C of the electron beam spot must be less than Dh+2b to prevent undesirable color emission. This can be expressed by the following Equation 1.
2C=2Ph−Dh−Fh Equation 1:

Therefore, with reference to Inequality 1 and Equation 1, the vertical width Dv of the phosphor layer 18 of the electron emission display of this embodiment can be set to satisfy the following Inequality 2 so that the light emission efficiency of the phosphor layers 18 can be improved to enhance the luminescence of the screen and the light emission uniformity of the pixel regions can be improved while suppressing undesirable color emission.
Fv<Dv<(Fv+2Ph−Dh−Fh) Inequality 2:

For example, when the horizontal pitch Ph between the pixel regions is 200 micrometers, the horizontal width Dh of the phosphor layer is 150 micrometers, and the horizontal and vertical widths Fh and Fv of the opening of the focusing electrode are respectively 30 micrometers and 200 micrometers, the vertical width Dv of the phosphor layer can be 200-420 micrometers according to Inequality 2. That is, in response to the luminescence required for the electron emission display, the vertical width of the phosphor layer is properly selected within the range of 200-420 micrometers.

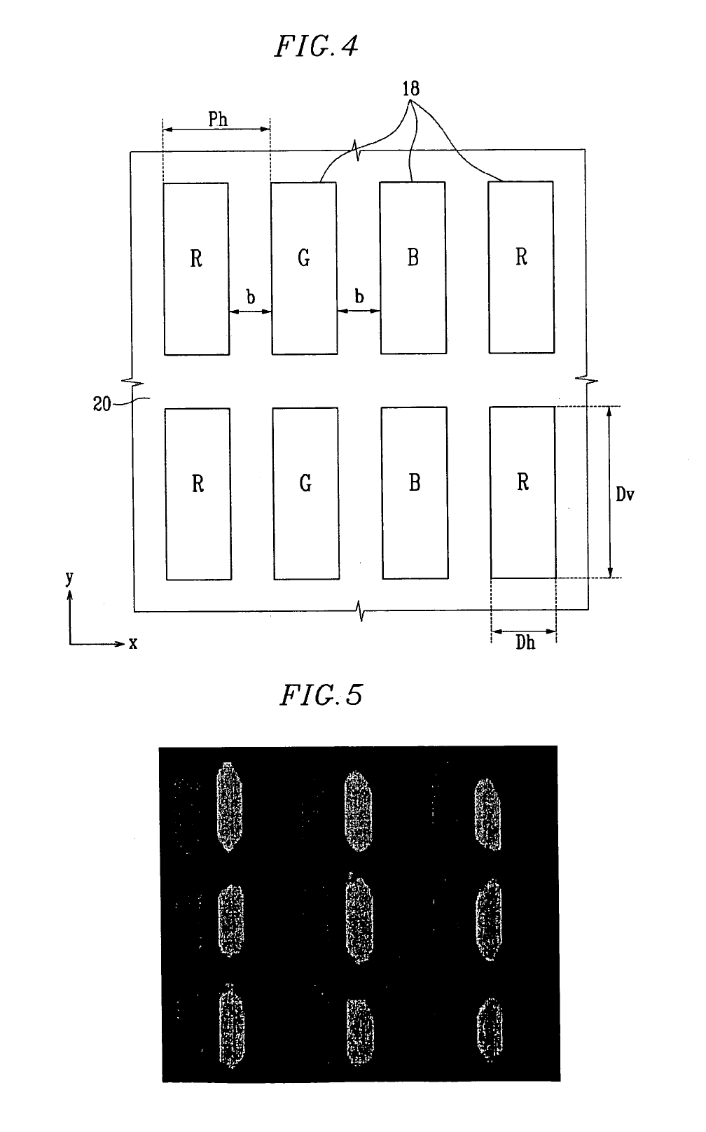

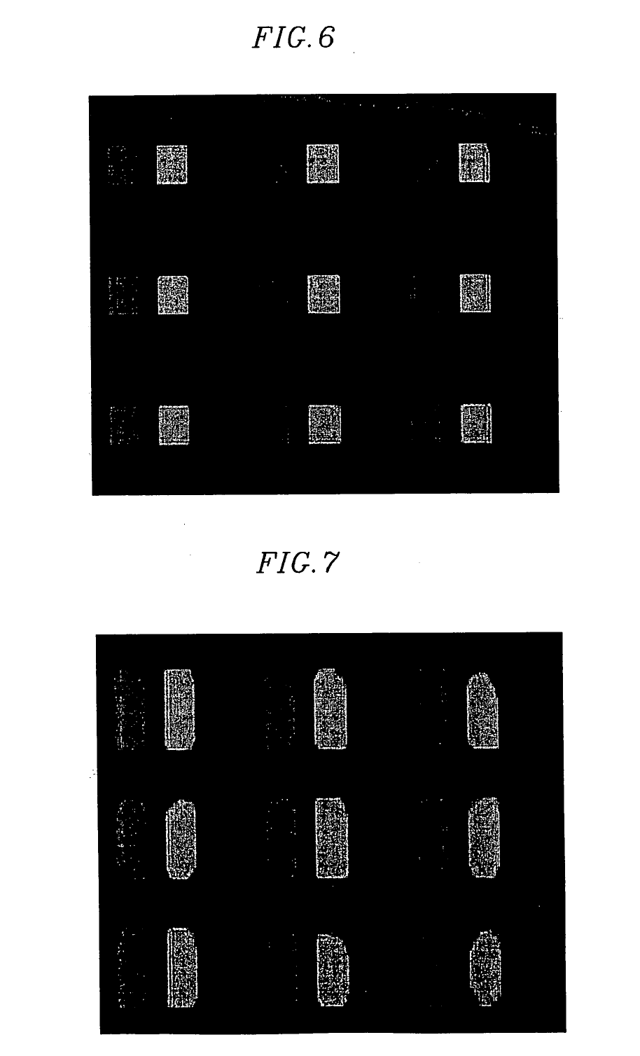

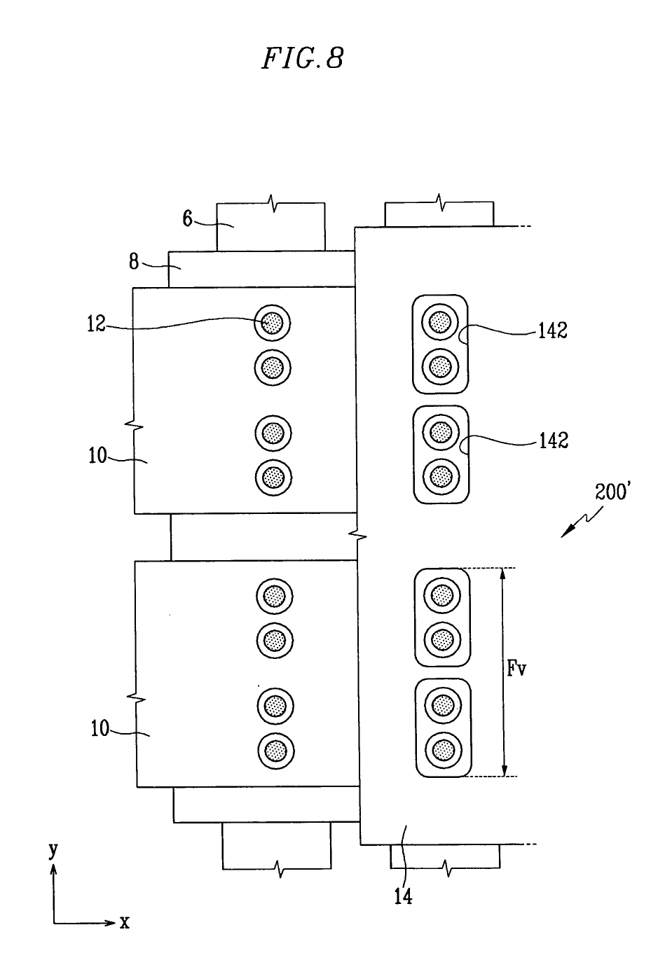

FIG. 5 is an enlarged photograph of a light emission pattern of phosphor layers of an electron emission display of a first comparative example where the vertical width of the phosphor layer is greater than Fv+2Ph−Dh−Fh. FIG. 6 is an enlarged photograph of a light emission pattern of phosphor layers of an electron emission display of a second comparative example where the vertical width of the phosphor layer is less than the vertical width Fv of the opening of the focusing electrode, and FIG. 7 is an enlarged photograph of a light emission pattern of phosphor layers of an electron emission display satisfying Inequality 2.

Referring first to FIG. 5, the electron emission display of the comparative example cannot emit light from an overall region of each phosphor layer but only from a part of each phosphor layer in response to the shape of the electron beam spot. Therefore, the light emission efficiency of the phosphor layer and the light emission uniformity of the pixel regions are low.

Referring to FIG. 6, although the electron emission display of the comparative example 2 can obtain a desirable light emission uniformity of the pixel regions, a size of the phosphor is too small to obtain a desirable luminescence.

Referring to FIG. 7, the electron emission display of the embodiment of the present invention uniformly emits light from the overall region of each phosphor layer while improving the light emission efficacy of the phosphor layer and the light emission uniformity of the pixel regions.

FIG. 8 is a partial top view of an electron emission unit of an electron emission display according to another embodiment of the present invention.

Referring to FIG. 8, openings 142 are formed on the focusing electrode 14 and two or more openings 142 are provided in each pixel region. The openings 142 are arranged in a longitudinal direction of the cathode electrode 6. In this case, Fv is a length between upper and lower ends of the openings 142 that are arranged in a longitudinal direction (in a direction of a Y-axis in the drawing) of the corresponding phosphor layer.

Although the electron emission display in the above exemplary embodiments have FEA elements, the present invention is not limited thereto. The present invention can be applied to an electron emission display having other types of electron emission elements.

Although exemplary embodiments of the present invention have been described in detail hereinabove, it should be clearly understood that many variations and/or modifications of the basic inventive concept taught herein still fall within the spirit and scope of the present invention, as defined by the appended claims.

What is claimed is:

1. An electron emission display, comprising:
first and second substrates arranged to face each other;
an electron emission region arranged on the first substrate;
a plurality of driving electrodes arranged on the first substrate and adapted to control electron emission of the electron emission region;
a focusing electrode arranged above the driving electrodes and including openings adapted to focus electrons passing therethrough; and
phosphor layers arranged on the second substrate, the phosphor layers respectively corresponding to each pixel region on the first substrate;
wherein the openings and the phosphor layer satisfy the following inequality:
F2<D2<(F2+2P1−D1−F1);
wherein F1 is a first width of the openings in a first direction of the first and second substrates, D1 is a first width of the phosphor layers in the first direction, F2 is a second width of the openings in a second direction perpendicular to the first direction, D2 is a width of the phosphor layers in the second direction, and P1 is a pitch between the pixel regions in the first direction.

2. The electron emission display of claim 1, wherein the first direction is a horizontal direction of the first and second substrates and the second direction is a vertical direction of the first and second substrates.

3. The electron emission display of claim 2, wherein the phosphor layers include red, green and blue phosphor layers and wherein the phosphor layers of differing colors are alternately arranged in the first direction and the phosphor layers of an identical color are arranged in the second direction.

4. The electron emission display of claim 2, wherein lateral axes of the openings and the phosphor layers are in the first direction and longitudinal axes of the openings and the phosphor layers are in the second direction.

5. The electron emission display of claim 4, wherein the openings of the focusing electrodes comprise one of a rectangular shape, an oval shape and a track shape.

6. The electron emission display of claim 4, wherein the phosphor layers are comprise either a rectangular shape or a rectangular shape having rounded corners.

7. The electron emission display of claim 1, wherein one of the openings on the focusing electrodes are provided for each pixel region defined on the first substrate.

8. The electron emission display of claim 1, wherein two or more openings on the focusing electrodes are provided for each pixel region defined on the first substrate and wherein the second width F2 of the openings is defined between upper and lower ends of the openings arranged at each pixel region in the second direction.

9. The electron emission display of claim 1, wherein the driving electrodes include first and second electrodes with an insulating layer interposed therebetween and wherein the electron emission region is electrically connected to one of the first and second electrodes.

10. The electron emission device of claim 1, wherein the electron emission region includes a material selected from the group consisting of carbon nanotubes, graphite, graphite nanofibers, diamonds, diamond-like carbon, C₆₀, and silicon nanowires.
